(19) United States
(12) Patent Application Publication
(10) Pub. No.: US 2005/0202326 A1
(43) Pub. Date: Sep. 15, 2005

(54) OPTIMIZED PLACEMENT OF SUB-RESOLUTION ASSIST FEATURES WITHIN TWO-DIMENSIONAL ENVIRONMENTS

(75) Inventors: Ronald L. Gordon, Poughkeepsie, NY (US); Alexey Y. Lvov, Terrytown, NY (US); Scott M. Mansfield, Hopewell Junction, NY (US); Maharaj Mukerjee, Wappingers Falls, NY (US); Evanthia Papadopoulou, White Plains, NY (US)

Correspondence Address: DELIO & PETERSON, LLC, 121 WHITNEY AVENUE, NEW HAVEN, CT, 06510, US

(73) Assignee: INTERNATIONAL BUSINESS MACHINES CORPORATION, Armonk, NY (US)

(21) Appl. No.: 10/708,515

(22) Filed: Mar. 9, 2004

(51) Int. Cl. G21K 5/10; G03C 5/00; G06F 17/50

(52) U.S. Cl. 430/30; 250/492.22; 716/21

(57) ABSTRACT

A method of creating a photomask layout for projecting an image of an integrated circuit design comprises creating a layout of spaced integrated circuit shapes to be projected via the photomask, determining bisectors between adjacent ones of the spaced integrated circuit shapes, and creating sub-resolution assist features along at least some of the bisectors between the adjacent ones of the spaced integrated circuit shapes. The bisectors may be determined by creating Voronoi cells around the spaced integrated circuit shapes. Preferably, the adjacent ones of the spaced integrated circuit shapes are parallel to each other and the sub-resolution assist features along the bisectors are parallel to the spaced integrated circuit shapes.

### BACKGROUND OF INVENTION

The present invention relates to the fabrication of integrated circuits and, in particular, to the creation of circuit layout and sub-resolution assist feature patterns on photomasks, in order to project an image of an integrated circuit design using a photolithographic process.

In the semiconductor industry, photolithography is used to transfer patterns corresponding to a circuit layout from a photomask to a semiconductor wafer to form a semiconductor device. The layout, and hence the patterns on the masks, are designed to conform to dimensional rules determined by the lithographic processing parameters, semiconductor processing parameters, and circuit design criteria to ensure that the patterns transfer properly and the circuit functions. Important layout design rules which tend to determine the overall size and density of the semiconductor device define the smallest width of a line or smallest space between two lines as the critical dimension (CD), and the minimum of the width of a given feature plus the distance to the adjacent feature edge as the minimum pitch.

Once the layout of the circuit is created as a pattern on the photomask, the photolithographic process utilizes an exposure tool to irradiate a layer of photoresist on the semiconductor wafer. As the critical dimensions of the layout approach the resolution limit of the lithography equipment, proximity effects (resulting from optical diffraction in the projection system) begin to influence the manner in which features on a mask transfer to the resist layer such that the masked and actual layout patterns begin to differ.

Features that have edges that are in close proximity to other features (referred to as densely packed edges) are more affected by proximity effects while features that have edges that are relatively isolated (referred to as isolated edges) are less affected by proximity effects. Since it is normally not possible to design a layout in which all features have the same minimum widths and separation spacings, sub-resolution assist features (SRAFs) (also referred to as scattering bars, intensity leveling bars or assist bars) have been developed in order to minimize or eliminate proximity effects between isolated and densely packed edges of features in a lithographic process. These sub-resolution assist features (SRAFs) are typically non-resolvable correction features that are placed next to isolated pattern or shape edges on a mask in order to adjust the edge intensity at the isolated edge to match the edge intensity at a densely packed edge and thereby cause the feature having the isolated edge to have nearly the same width as features having densely packed edges.

Numerous methods for placing SRAFs have been disclosed in the prior art. SRAFs may be generated in a relatively straightforward manner for one-dimensional circuit layouts. However, when dealing with two-dimensional circuit layouts, conflicts occur when attempting to apply 1D rules to 2D layouts, particularly within the normal constraints of manufacturing rules. Consequently, the prior art solutions are generally cumbersome to apply to 2D layouts.

### SUMMARY OF INVENTION

Bearing in mind the problems and deficiencies of the prior art, it is therefore an object of the present invention to provide a method of creating a photomask layout of a two-dimensional circuit pattern which incorporates SRAFs.

It is another object of the present invention to provide a method of generating SRAFs that can be applied consistently to minimize or eliminate conflicts, within applicable manufacturing constraints.

A further object of the invention is to provide a simplified method of generating SRAFs in 2D circuit layouts.

Still other objects and advantages of the invention will in part be obvious and will in part be apparent from the specification.

The above and other objects, which will be apparent to those skilled in art, are achieved in the present invention which is directed to a method of creating a photomask layout for projecting an image of an integrated circuit design comprising creating a layout of spaced integrated circuit shapes to be projected via the photomask, determining bisectors, such as Voronoi bisectors, between adjacent ones of the spaced integrated circuit shapes, and creating sub-resolution assist features along at least some of the bisectors between the adjacent ones of the spaced integrated circuit shapes.

The bisectors may be determined by creating Voronoi cells around the spaced integrated circuit shapes. Preferably, the adjacent ones of the spaced integrated circuit shapes are parallel to each other and the sub-resolution assist features along the Voronoi bisectors are parallel to the spaced integrated circuit shapes.

The method may include identifying different types of vertices for the bisectors prior to creating the sub-resolution assist features, and prioritizing creation of the sub-resolution assist features in accordance with the type of vertex. Also, the method may include extending at least some of the sub-resolution assist features beyond the bisectors on which they are created, including extending those sub-resolution assist features to connect to other sub-resolution assist features. The method may further include removing at least one of the sub-resolution assist features along the bisectors prior to finalizing the photomask layout.

Preferably, the integrated circuit shapes are two-dimensional and include shapes having edges parallel and perpendicular to each other, between which the bisectors are located. The two-dimensional integrated circuit shapes may include shapes having lengths of parallel edges in which an edge of one shape ends at a point within the length of the other shape, between which the bisectors are located.

In another aspect, the present invention is directed to a program storage device readable by a machine, tangibly embodying a program of instructions executable by the machine to perform the aforedescribed method steps for creating a photomask layout for projecting an image of an integrated circuit design.

In a further aspect, the present invention is directed to an article of manufacture comprising a computer-usable medium having computer readable program code means embodied therein for creating a photomask layout for projecting an image of an integrated circuit design according to the method described above.

### BRIEF DESCRIPTION OF DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a top plan view of the integrated circuit design shapes for which a photomask is to be fabricated, and a portion of the Voronoi cells created around the shapes.

FIG. 2 is a top plan view of a vertex created by the Voronoi boundaries between one type of adjacent circuit patterns or shapes.

FIG. 3 is a top plan view of a vertex created by the Voronoi boundaries between another type of adjacent circuit patterns or shapes.

FIG. 4 is a top plan view of the integrated circuit design shapes of FIG. 1, showing the initial placement of SRAFs along the Voronoi cell bisectors in accordance with the present invention.

FIG. 5 is a top plan view of the integrated circuit design shapes of FIG. 1, showing the subsequent deletion and extension of the SRAFs of FIG. 4 in accordance with the present invention.

FIG. 6 is a schematic view of an EDA tool or computer containing program code in a program storage device for executing the method of creating a photomask layout in accordance with the present invention.

### DETAILED DESCRIPTION

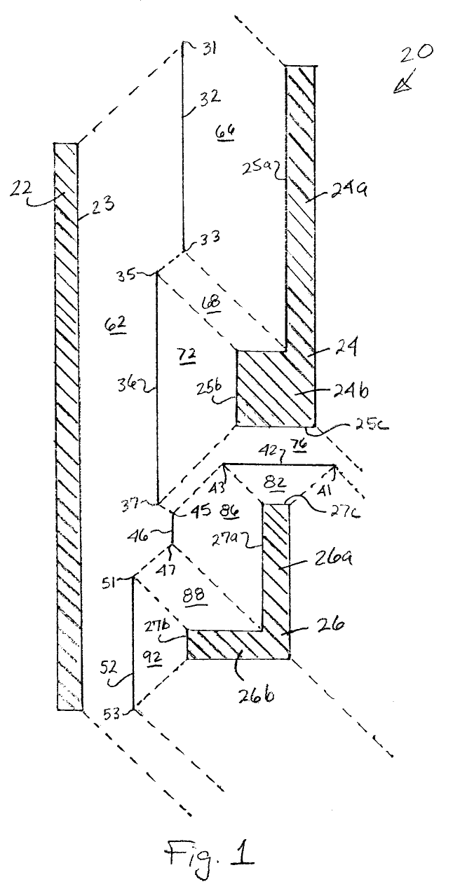

In describing the preferred embodiment of the present invention, reference will be made herein to FIGS. 1-6 of the drawings in which like numerals refer to like features of the invention.

The present invention employs a mathematical construct, i.e., a Voronoi diagram, to determine initial placement of the sub-resolution assist features, or SRAFs. A Voronoi diagram of a collection of geometric objects is a partition of space into cells, each of which consists of the points closer to one particular object or shape than to any others. The Voronoi diagram identifies pair wise interaction between shapes, and provides information about the neighborhood of a shape. The shared boundaries of adjacent Voronoi cells, between shape edges, are also referred to herein as Voronoi bisectors, or simply bisectors, since they establish the midpoint between adjacent edges of the circuit shapes to be projected. The bisectors are defined to be the locus of points equidistant from edges of adjacent shapes. “Equidistant” is defined relative to a distance metric. In the preferred embodiment of the present invention, the L-infinity metric is used:
dist[(x₁, y₁), (x₂, y₂)]=max(|x₁−x₂|, |y₁−y₂|)

Other distance metrics, such as the L1 or L2 (i.e. Euclidean) metrics, or other suitable distance metrics may be used to define the bisectors.

FIG. 1 depicts a two-dimensional circuit layout 20 comprising shapes which are to be projected via a mask onto a wafer resist layer to lithographically produce a series of conductive lines. Line shape 22 comprises a rectangular vertical line. Line shape 24 comprises a reverse L shape of vertical rectangular segment 24a and horizontal square segment 24b. Likewise, line shape 26 comprises a reverse L shape of vertical rectangular segment 26a and horizontal rectangular segment 26b. Line shape 22 has edge 23 closest to and facing shapes 24 and 26. Shape 24 has edges 25a and 25b closest to and facing portions of line edge 23, and shape 26 has edges 27a and 27b closest to and facing portions of line edge 23. Shape segments 24b and 26a also have edges 25c and 27c, respectively, facing each other.

The Voronoi diagrams of the shapes and shape segments 22, 24a, 24b, 26a and 26b are also shown in FIG. 1. Solid and dashed lines subdivide the area between shapes 22, 24 and 26 into different cells or regions. Cell 62 represents the locus of points closer to line edge 23 than any other shape in the figure. Likewise, cell 66 represents the locus of points closer to line segment edge 25a than any other shape or shape segment; cell 72 represents the locus of points closer to line segment edge 25b; cell 76 represents the locus of points closer to line segment edge 25c; cell 82 represents the locus of points closer to line segment edge 27c; cell 86 represents the locus of points closer to line segment edge 27a; and cell 92 represents the locus of points closer to line segment edge 27b. The horizontal shape edges without bisectors include cell 68, representing the locus of points closer to the upper edge of line segment 24b, and cell 88, representing the locus of points closer to the upper edge of line segment 26b.

Except for the lines at the periphery of FIG. 1, the lines that comprise the Voronoi boundaries all meet at points or vertices, with the Voronoi bisectors between adjacent shape edges depicted as solid lines and the other Voronoi boundaries depicted as dashed lines. Bisector 32, bounded by vertices 31 and 33, represents the locus of midpoints on the Voronoi boundary between shape edge 23 and shape edge 25a; bisector 36, bounded by vertices 35 and 37, represents the locus of midpoints on the Voronoi boundary between shape edge 23 and shape edge 25b; bisector 46, bounded by vertices 45 and 47, represents the locus of midpoints on the Voronoi boundary between shape edge 23 and shape edge 27a; bisector 52, bounded by vertices 51 and 53, represents the locus of midpoints on the Voronoi boundary between shape edge 23 and shape edge 27b; and bisector 42, bounded by vertices 41 and 43, represents the locus of midpoints on the Voronoi boundary between shape edge 25c and shape edge 27c.

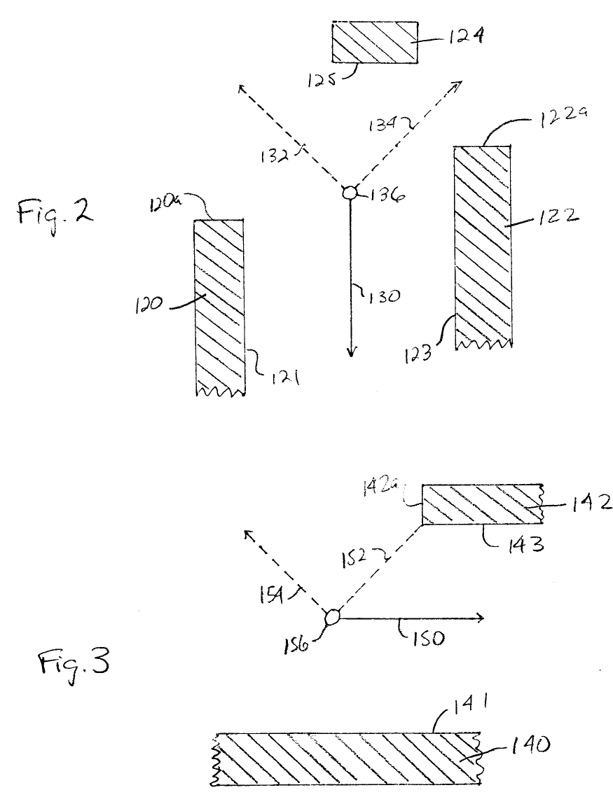

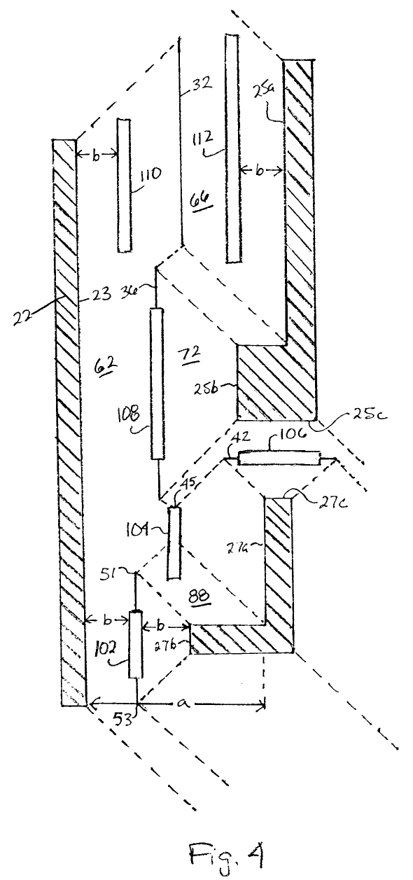

Of the different types of vertices shown in FIG. 1 and otherwise possible, two different types of vertices are depicted in particular in FIGS. 2 and 3. A first type of vertex, referred to as a Y vertex, is depicted in FIG. 2 as an interruption between three shape edges, wherein in a two-dimensional (2D) environment two vertical circuit shapes 120, 122 and one horizontal shape 124 have corresponding adjacent facing edges 121, 123, 125, respectively. Line shape 124 is perpendicular to and spaced from ends 120a, 122a of parallel line shapes 120, 122. Voronoi boundaries 130, 132 and 134, intersecting at vertex 136, demark the edges of the regions closest to each of the edge shapes 121, 123 and 125, and line 130 is the bisector establishing the locus of midpoints between edges 121 and 123. A similar Y vertex may be created with comparable confluence of other pairs of vertical shape edges with a horizontal shape edge, such as if FIG. 2 were rotated 180°, or where there are adjacent each other one vertical and two horizontal edges, as would be if FIG. 2 were rotated 90°. Another vertex, referred to as a one-dimensional (1D) fragmented vertex, is shown in FIG. 3 as an interruption of a shape corner with a shape edge. Two parallel lines 140, 142 have adjacent facing edges 141, 143, respectively. End 142a of line shape 142 ends at a point within the horizontal length of shape 140 edge 141. Vertex 156 marks the intersection of Voronoi boundaries 152, 154 and Voronoi bisector 150 (between edges 141, 143). Other 1D-fragmented vertices can be seen if FIG. 3 were rotated by 90 or 180°.

While the generation of Voronoi cells and, consequently, the location of bisectors and vertices associated with these cells form the primary basis for locating SRAFs according to the present invention, geometric manufacturing rules and photography rules also are be employed in the preferred embodiment. The manufacturing rules set the minimum spacing of SRAFs to the circuit shapes, and the minimum width and aspect ratio of the individual SRAFs. The minimum spacing s of an SRAF to the closest edge of a shape and the minimum width w of an individual SRAF are determined by mask manufacturability requirements. The aspect ratio of an individual SRAF is the ratio of the SRAF length l to the width w, and the minimum aspect ratio is preferably 5. The SRAFs are placed parallel to the closest edges that they are intended to assist.

The photography rules determine the number and spacing of SRAFs between parallel shape edges. For circuit shape edges less than a minimum spacing, the adjacent edges themselves are densely packed edges and consequently no SRAFs are needed. For edges that are farther apart than a maximum spacing x and no longer qualify as densely packed edges, a single SRAF is placed midway between the edges. Edges that are too far apart, i.e., at a spacing of 2× or more, to benefit from a single midway SRAF receive two intermediate SRAFs, each placed at the minimum distance s from the adjacent edge. Edges that are farther apart may receive three or more intermediate SRAFs, so that each edge has a close SRAF at the minimum distance s, with the additional SRAFs placed between the close SRAFs. The optimal distances between edges before SRAFs are employed, the distance between SRAFs and edges, and the number of SRAFs to use between edges, may be determined without undue experimentation for each photolithographic system.

Voronoi edge types for the different circuit shapes are also determined in the preferred method of the present invention, based on the different vertices described above. Referring back to FIG. 1, a first edge type has a bisector that has Y vertices (FIG. 2) at its ends between two edges. An example of such type 1 edge is bisector 46 between edge pairs 23 and 27a. A second edge type has a bisector that has a 1D-fragmented vertex (FIG. 3) on at least one end, such as a 1D-fragmented vertex at one end and a Y vertex at the other, between two edges. An example of such type 2 edges is bisector 32 between edge pairs 23 and 25a. The third type of edge is a default condition, where the edges are greater than the maximum distance at which a single intermediate SRAF can be effective. In this type 3 edge, more than one SRAF is used between the edges, with the closest SRAFs being the minimum distance s from each edge.

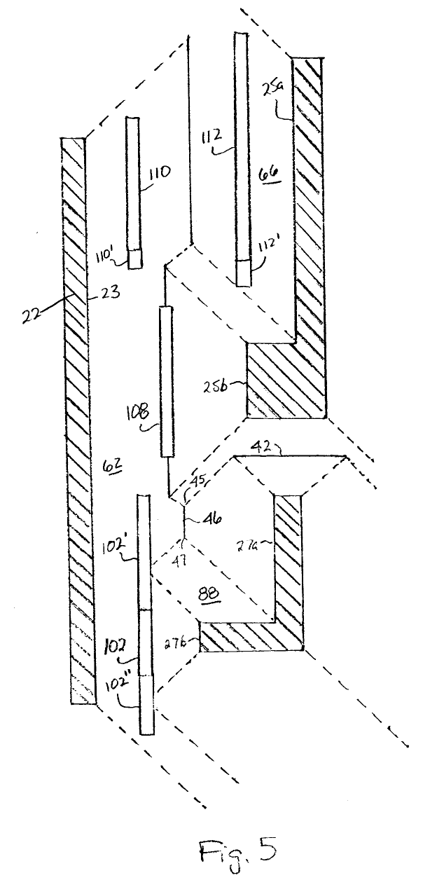

In the first stage of placing SRAFs according to the preferred method of the present invention, the Voronoi boundaries are determined for the circuit layout shapes to be projected, and the SRAFs are positioned according to them, with no regard as to minimum SRAF length. The determination of Voronoi boundaries for the exemplary circuit layout was shown in FIG. 1. In FIG. 4, there is shown the initial creation and positioning of SRAFs along the Voronoi boundaries for the shapes of FIG. 1, with the different edge types being addressed in order. For the type 1 edge, SRAF 104 is created along bisector 46 (FIG. 1) between edge pairs 23 and 27a, to support both of these edges. Distance a between edges 23 and 27a is less than the maximum edge distance 2x, and is consequently within that distance for which the edges may benefit from the single midway SRAF 104. In the example shown, the SRAF extends at the upper end to vertex 45 and extends at the lower end beyond the opposite Y vertex (47 in FIG. 1). While normally an SRAF would extend only to a distance s from a vertex, SRAF 104 extends to vertex 45 and beyond vertex 47 because it then reaches the maximum area without violating ground rules.

Following the initial location of SRAFs for type 1 edges, the type 2 edges are addressed. Edge pairs 23 and 27b qualify as type 2 edges, because vertices 51 and 53 are 1D-fragmented vertices. SRAF 102 is located along bisector 52, midway between edges 23 and 27b, and distance b from each. Distance b is greater than or equal to s, the minimum spacing, and less than maximum spacing x. SRAF 102 extends at least the length of the shorter of the edge pairs, 27b, and the ends terminate at least the distance s away from the vertices 51, 53. Similarly, type 2 edge pairs 25c, 27c and 23, 25b, have 1D-fragmented vertices on the ends of bisectors 42 and 36, respectively. SRAFs 106 and 108 qualify for placement on bisectors 42, 36, respectively, because the distance from each edge is between minimum s and maximum x. As with SRAF 102, the ends of SRAFs 106 and 108 terminate at least a distance s from the respective vertices at the ends of the bisectors. The last type 2 edge pair depicted, edges 23 and 25a, have a spacing greater than the maximum edge spacing 2x, and therefore cannot have an SRAF placed on bisector 32. Instead, two SRAFs 110, 112 are located between the edges, each at a distance b (equal to the minimum spacing s) from their respective closest edges which they support. The upper ends of SRAFs 110 and 112 terminate at a distance s beyond the ends of the closest edges 23, 25a, respectively. The lower ends terminate at the locations shown because it reaches the minimum distance allowed by ground rules to the projection of SRAF 108.

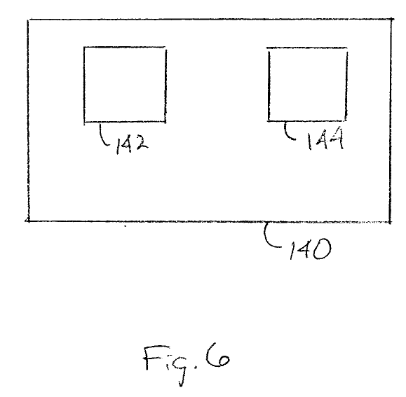

In the preferred second stage of placing SRAFs, an attempt is made to linearly extend the initial SRAFs. However, prior to such extension, the initially placed SRAFs are reviewed to determine whether they can be extended at all, and in some cases, they are deleted if they are non-extendible. Also, as noted in the manufacturing rules, each SRAF must have a length at least five times its width, and those that violate this rule are deleted. For example, horizontal SRAF 106 and SRAF 104 are deleted because they both violate this rule. Following any deletion of SRAFs, other SRAFs are examined for possibility of extension within the same Voronoi cell or into neighboring cells. In FIG. 5, SRAF 102 is extended at both the upper and lower end by sections 102′, 102″, respectively, within its same cell 62 to maximize its coverage along the length along edge 23, without conflicting with SRAF 108. The upper end section 102′ has been extended to cover the entire length (and more) of deleted initially-placed SRAF 104. The lower end of extension section 102″ extends only distance s beyond the end of edge 23. Likewise, both SRAFs 110 and 112 are extended at their lower ends by sections 110′, 112′, respectively, within their same cells 62, 66, respectively, to maximize coverage along the lengths of edges 23 and 25a, respectively, before they conflict with SRAF 108. However, it is preferred that only parallel or collinear SRAFs are merged, and that SRAFs perpendicular to each other are never merged. Also, it is preferred that SRAFs that are perpendicular to each other should never be extended into the same Voronoi cell.

Before finalizing the layout of the SRAFs, subsequent extensions to merge and unite neighboring SRAFs may be made. These subsequent extensions do not delete any already-placed SRAFs, and add jogs or other heuristic improvements to increase coverage of edges.

The method of the present invention for creating a photomask layout for projecting an image of an integrated circuit design may be implemented by a computer program or software incorporating the process steps and instructions described above in otherwise conventional program code and stored on an electronic design automation (EDA) tool or an otherwise conventional program storage device. These instructions include the generation of Voronoi cells, and the creation and extension of the SRAFs along and beyond the Voronoi bisectors. As shown in FIG. 6, the program code, as well as any input information required, may be stored in EDA tool or computer 140 on program storage device 142, such as a semiconductor chip, a read-only memory, magnetic media such as a diskette or computer hard drive, or optical media such as a CD or DVD ROM. Computer system 140 has a microprocessor 144 for reading and executing the stored program code in device 142 in the manner described above.

Thus, the present invention uses the Voronoi diagrams, which encode the two dimensional pattern neighborhood information, as a map to guide the generation of SRAFs along the edges of circuit pattern shapes. It generates the SRAFs in a consistent manner so that there are no conflicts with other SRAFs and in a manner that satisfies manufacturing constraints. In its preferred embodiment, it employs only primary SRAFs, i.e., only one SRAF per edge, and provides a simplified method of generating SRAFs in 2D circuit layouts.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

1. A method of creating a photomask layout for projecting an image of an integrated circuit design comprising:
creating a layout of spaced integrated circuit shapes to be projected via the photomask;
determining bisectors between adjacent ones of the spaced integrated circuit shapes; and
creating sub-resolution assist features along at least some of the bisectors between the adjacent ones of the spaced integrated circuit shapes.

2. The method of claim 1 wherein bisectors are determined by creating Voronoi cells around the spaced integrated circuit shapes.

3. The method of claim 1 wherein the adjacent ones of the spaced integrated circuit shapes are parallel to each other and the sub-resolution assist features along the bisectors are parallel to the spaced integrated circuit shapes.

4. The method of claim 1 further including identifying different types of vertices for the bisectors prior to creating the sub-resolution assist features, and prioritizing creation of the sub-resolution assist features in accordance with the type of vertex.

5. The method of claim 1 further including extending at least some of the sub-resolution assist features beyond the bisectors on which they are created.

6. The method of claim 1 further including extending at least some of the sub-resolution assist features beyond the bisectors on which they are created to connect to other sub-resolution assist features.

7. The method of claim 1 further including removing at least one of the sub-resolution assist features along the bisectors prior to finalizing the photomask layout.

8. The method of claim 1 wherein the integrated circuit shapes are two-dimensional and include shapes having edges parallel and perpendicular to each other, between which the bisectors are located.

9. The method of claim 1 wherein the integrated circuit shapes are two-dimensional and include shapes having lengths of parallel edges in which an edge of one shape ends at a point within the length of the other shape, between which the bisectors are located.

10. A program storage device readable by a machine, tangibly embodying a program of instructions executable by the machine to perform method steps for creating a photomask layout for projecting an image of an integrated circuit design, said method steps comprising:
creating a layout of spaced integrated circuit shapes to be projected via the photomask;
determining bisectors between adjacent ones of the spaced integrated circuit shapes; and
creating sub-resolution assist features along at least some of the bisectors between the adjacent ones of the spaced integrated circuit shapes.

11. The program storage device of claim 10 wherein, in the method, bisectors are determined by creating Voronoi cells around the spaced integrated circuit shapes.

12. The program storage device of claim 10 wherein, in the method, the adjacent ones of the spaced integrated circuit shapes are parallel to each other and the sub-resolution assist features along the bisectors are parallel to the spaced integrated circuit shapes.

13. The program storage device of claim 10 further including, in the method, identifying different types of vertices for the bisectors prior to creating the sub-resolution assist features, and prioritizing creation of the sub-resolution assist features in accordance with the type of vertex.

14. The program storage device of claim 10 further including, in the method, extending at least some of the sub-resolution assist features beyond the bisectors on which they are created.

15. The program storage device of claim 10 further including, in the method, extending at least some of the sub-resolution assist features beyond the bisectors on which they are created to connect to other sub-resolution assist features.

16. An article of manufacture comprising a computer-usable medium having computer readable program code means embodied therein for creating a photomask layout for projecting an image of an integrated circuit design, the computer readable program code means in said article of manufacture comprising:
computer readable program code means for creating a layout of spaced integrated circuit shapes to be projected via the photomask;
computer readable program code means for determining bisectors between adjacent ones of the spaced integrated circuit shapes; and
computer readable program code means for creating sub-resolution assist features along at least some of the bisectors between the adjacent ones of the spaced integrated circuit shapes.

17. The article of manufacture of claim 16 wherein bisectors are determined by creating Voronoi cells around the spaced integrated circuit shapes.

18. The article of manufacture of claim 16 wherein the adjacent ones of the spaced integrated circuit shapes are parallel to each other and the sub-resolution assist features along the bisectors are parallel to the spaced integrated circuit shapes.

19. The article of manufacture of claim 16 wherein the computer readable program code means in said article of manufacture further includes computer readable program code means for identifying different types of vertices for the bisectors prior to creating the sub-resolution assist features, and prioritizing creation of the sub-resolution assist features in accordance with the type of vertex.

20. The article of manufacture of claim 16 wherein the computer readable program code means in said article of manufacture further includes computer readable program code means for extending at least some of the sub-resolution assist features beyond the bisectors on which they are created.
